(19) United States
(12) Patent Application Publication
(10) Pub. No.: US 2026/0132738 A1
(43) Pub. Date: May 14, 2026

(54) METHOD FOR OPERATING A COMBUSTION SYSTEM OF A TURBOMACHINE FOR A FLIGHT PROPULSION SYSTEM, AND TURBOMACHINE

(71) Applicant: MTU Aero Engines AG, München (DE)

(72) Inventors: Oliver Schmitz, Munich (DE); Marco Konle, Vaterstetten (DE); Hermann Klingels, Dachau (DE)

(73) Assignee: MTU Aero Engines AG, München (DE)

(21) Appl. No.: 18/695,694

(22) PCT Filed: Sep. 1, 2022
(86) PCT No.: PCT/DE2022/100646

§ 371 Date: Mar. 26, 2024

(30) Foreign Application Priority Data
Sep. 30, 2021 (DE) 10 2021 125 384.5

(51) Int. Cl. F02C 3/30

(52) U.S. Cl. CPC F02C 3/30; F05D 2220/323; F05D 2260/213

(57) ABSTRACT

The invention relates to a method for operating a combustion system of a turbomachine for a flight propulsion system, including a compressor, a combustion chamber, a turbine, a heat exchanger arranged downstream of the turbine, and a fuel treatment system. According to the invention, steam is produced in the heat exchanger and guided into a mixing chamber of the fuel treatment system, to which, furthermore, fuel is supplied. The invention further relates to a turbomachine including a combustion system, in particular for using the method.

### BACKGROUND OF THE INVENTION

The invention relates to a method for operating a combustion system of a turbomachine for a flight propulsion system, comprising a compressor, a combustion chamber, a turbine, a heat exchanger arranged downstream of the turbine, and a fuel treatment system as well as a turbomachine that is suitable for carrying out the method.

Turbomachines for flight propulsion systems are operated at present exclusively using fossil fuels, such as kerosene, which, during the combustion thereof, form environmentally harmful pollutants. Known from WO 2019/223823 A1 is a flight propulsion system that, on account of its conception, has the potential for reducing emissions that are harmful to the environment and to the climate. The propulsion system combines a gas turbine cyclic process with a steam turbine process in one machine. In a steam generator arranged downstream of the turbine, steam is produced by exhaust gas energy and is then fed to the region of the combustion chamber. The higher mass flow in the turbine due to the addition of steam brings about an increase in power and, through the recovery of heat, the thermal efficiency of the turbomachine is improved.

Such new propulsion concepts are suited for the use of many fuels. Thus, besides kerosene, it is also possible to combust, for example, sustainable aviation fuel (SAF), liquid hydrogen (LH₂), liquid natural gas (LNG), or methane (CH₄). Because a short-term switch to alternative fuels is not to be expected on a large scale, it seems appropriate to provide turbomachines for the use of liquid kerosene and to improve the environmental impact of air traffic. Through a higher thermal efficiency, it is possible to reduce CO₂ emissions and, through the separation of water from the exhaust gas, to prevent or at least to reduce the formation of climate-relevant contrails. Through the injection of steam into the combustion chamber, temperature peaks can be prevented and the formation of nitrogen oxides (NO_{X}) thereby reduced, whereby the formation of further pollutants, such as carbon monoxide (CO), uncombusted hydrocarbons (UHC), and soot (C) should also be reduced as much as possible.

This necessitates a design that is adapted to the specific properties of the working medium. In addition, steam offers new possibilities of fuel processing and thus a new concept for low-pollutant combustion in a turbomachine.

For a better understanding of the invention, the combustion and the pollutant formation in a conventional combustion chamber as well as measures for reducing emissions will be explained briefly by way of introduction:

For a stoichiometric combustion of kerosene, a mass-related air-fuel ratio of LBV_{stoich}=14.63 is required. In order to characterize combustion conditions, the so-called equivalence ratio φ is also used:

$$ϕ = \frac{L B {V}_{stoich}}{L B V}$$

In the case of ideal stoichiometric combustion of kerosene with air, only carbon dioxide (CO₂) and water (H₂O) are formed. In the case of real combustion of kerosene, the conversion does not take place in one step, but rather the oxidation of the fuel occurs in several intermediate steps. If, for example, the combustion is interrupted prematurely by rapid cooling, by inhomogeneities in the mixture distribution, or by other processes, then intermediate products of the combustion can be present in the exhaust gas. Side reactions during combustion also ensue as a result of high temperatures. Accordingly, in the case of real combustion, in addition to carbon dioxide and water, further products, in particular pollutants, are to be found in the exhaust gas. The key ones are carbon monoxide (CO), uncombusted hydrocarbons (UHC), soot (C), and nitrogen oxides (NO_{X}).

Carbon monoxide (CO) is present in the exhaust gas when the carbon contained in the fuel is not oxidized fully. It can form owing to the lack of oxygen, an inadequate mixing of the fuel with the combustion air, a residence time in the combustion zone that is too short, or a cooling of the mixture in the combustion chamber that is too rapid. In the combustion zone, even for an excess of air, high temperatures result in the occurrence of an increased concentration of carbon monoxide, because carbon dioxide (CO₂) dissociates to carbon monoxide (CO) at high temperatures.

The ratio of air to fuel, LBV, influences the CO emission substantially. In the case of rich equivalence ratios, too little oxygen is present, so that the carbon monoxide cannot be oxidized completely to carbon dioxide. In the case of very lean mixture ratios, low temperatures ensue in the combustion zone. When the residence time of the mixture in the combustion zone is not sufficient to complete the oxidation of carbon monoxide, increased CO emissions result.

The fuel processing also influences the CO emission. Liquid fuels enter the combustion zone generally in the form of tiny, finely dispersed droplets. Before the hydrocarbons can be oxidized, they have to be vaporized and to mix with the air. The larger the injected droplets, the longer it takes for the vaporization to occur. Moreover, regions of very high fuel concentration are formed around the droplets, so that a rich combustion occurs locally. Hence, large fuel droplets also lead to higher CO emission.

Uncombusted hydrocarbons (UHC) include the liquid or vaporous residues of the fuel and the short-chain hydrocarbons in the exhaust gas that are formed from the fuel by cleavage. The emission of uncombusted hydrocarbons is also to be traced back to an incomplete combustion. The causes of this, similarly to the formation of carbon monoxide (CO), are an inadequate fuel processing, a residence time of the mixture in the combustion zone that is too short, and a cooling of the mixture on the combustion chamber walls that is too rapid or else are due to a supply of cool air.

Included in nitrogen oxides (NO_{X}) are all compounds of nitrogen with oxygen. The three most important factors influencing the formation of thermal nitrogen oxides (NO_{X}) are hereby the temperature, the residence time of the mixture at the high temperatures, and the equivalence ratio. The temperature has the greatest influence on the formation of thermal nitrogen oxides. At combustion temperatures above 1900 K, the rate of formation of nitrogen oxide increases strongly. The longer the mixture resides in the combustion zone and the larger the region of high temperature, the greater are the nitrogen oxide emissions. The equivalence ratio also influences the NO_{X} emissions. It is highest in the case of a lean mixture. This arises through the overlap of two effects. On the one hand, the nitrogen oxide formation requires oxygen. The leaner the mixture, the more oxygen is available. The other effect ensues from the interrelation between the equivalence ratio and the combustion temperature. The highest temperatures arise for slightly rich combustion. Taken together, these two effects result in the maximum of the formation of nitrogen oxides being reached for slightly lean combustion.

At lower temperatures, prompt NO_{X} forms. In this reaction mechanism, nitrogen oxides are formed by combustion radicals. The CH radicals required for these reactions arise more strongly in fuel-rich combustion zones. At low combustion temperatures and lean premixing, nitrogen oxides form by way of the so-called dinitrogen mechanism.

Soot (C) is a solid that consists in large part of carbon. Soot is formed during the combustion of kerosene and air at pressures above 6 bar and in the case of rich mixtures with equivalence ratios above 1.3.

The pursuit of lower fuel consumption and thus lower CO₂ emissions aims at the achievement of cyclic processes with higher temperatures and pressure ratios. However, both of them lead to a higher output of nitrogen oxides. The combustion temperature has a very large influence on pollutant emission. Keeping the output of pollutants low results in a conflict for the combustion temperature being targeted. In order to reduce the CO emissions and the similarly behaving UHC emissions, a high combustion temperature and a high residence time are desired. Both of them promote nitrogen oxide formation, however. Only in an intermediate temperature range are all pollutant emissions relatively low, so that this temperature range is to be aimed for. The combustion temperature is determined in conventional gas turbines by the combustion chamber inlet temperature and by the equivalence ratio in the primary zone. The desired intermediate temperatures can be attained either via a lean equivalence ratio or via a rich equivalence ratio.

The combustion in an aircraft engine also needs to proceed stably under strongly varying combustion chamber inlet conditions. The most important stationary operating states of an aircraft engine are take-off, cruise at high altitude, flight idle, and ground idle. In the case of conventional engines, these operating states have consequences for the combustion chamber parameters. In comparison to take-off, the inlet pressure in the combustion chamber varies by a factor of about 10, the fuel mass flow by a factor of about 20, and the inlet temperature and the global mixing ratio by a factor of about 2. Thus, for example, on transitioning from cruise flight to descent flight, the mixture in the combustion chamber becomes markedly leaner and, in addition, the combustion chamber pressure and the combustion chamber inlet temperature decrease. The margin to the lean blowout limit is thereby reduced

In the past, many concepts for a low-pollutant combustion have been developed for stationary gas turbines and flight gas turbines. Different measures have thereby been taken, all of which aim at preventing high peak temperatures and the thereby ensuing nitrogen oxide formation and, at the same time, of keeping the emission of carbon monoxide and uncombusted hydrocarbons low.

The most important concepts are:
rich quench lean (RQL) combustion
lean direct injection (LDI)
lean premixed prevaporized (LPP) combustion
lean premixed (LP) combustion
staged combustion (generally staged in terms of fuel).

### SUMMARY OF THE INVENTION

Based on this, a problem of the present invention is to propose an improved method for operating a combustion system of a turbomachine for a flight propulsion system as well as a turbomachine, which make possible low pollutant emissions in conjunction with a stable and reliable combustion. This is achieved in accordance with the present invention. Advantageous embodiments of the invention are discussed in detail below.

Proposed for the solution of the problem in a first aspect is a method for operating a combustion system of a turbomachine for a flight propulsion system, which comprises a compressor, a combustion chamber, a turbine, a heat exchanger arranged downstream of the turbine, and a fuel treatment system, with the following steps:
a) production of steam in the heat exchanger,
b) feeding of steam into a mixing chamber of the fuel treatment system,
c) feeding of fuel into the mixing chamber of the fuel treatment system,
d) formation of a steam/fuel mixture in the mixing chamber, and
e) supplying of the steam/fuel mixture to a combustion chamber of the turbomachine.

Such a turbomachine for a flight propulsion system comprises a compressor, a combustion chamber, and a turbine. During the operation of the turbomachine, air is compressed in a compressor, mixed with fuel in a combustion chamber, and ignited in order to drive a turbine. Furthermore, the proposed turbomachine has a heat exchanger arranged downstream of the turbine, in which, in the step a) of the proposed method, steam is produced, in particular from the water extracted from the exhaust gas of the turbomachine by use of the exhaust gas energy. The turbomachine further has a fuel treatment system for processing the fuel prior to the combustion thereof in the combustion chamber.

In the step b) of the proposed method, at least a part of the steam produced in the heat exchanger is carried via a steam line or steam feed to a mixing chamber of the fuel treatment system. In the step c), fuel is fed into the mixing chamber of the fuel treatment system and thereby supplied to the steam introduced there, whereby the fuel vaporizes. A steam/fuel mixture is then formed in the mixing chamber from the steam and the fuel in the step d) and, finally, in the step e), is supplied to a combustion chamber of the turbomachine.

In the proposed method, the fuel is advantageously vaporized in a mixing chamber separated spatially from the combustion chamber and is supplied to the combustion chamber of the turbomachine only after the formation of a steam/fuel mixture. In a conventional feeding of fuel to a combustion chamber, regions with different equivalence ratios form around the vaporizing fuel droplets. If such a mixture containing droplets enters the combustion zone, the fuel reacts with the surrounding air primarily in the near-stoichiometric regions around the fuel droplets, thus promoting locally very high temperatures and thereby increased NO_{X} emissions. Accordingly, the proposed method makes possible a homogeneous distribution of the fuel in the steam and thus creates a basis for a stable and homogeneous combustion in the combustion chamber, thereby resulting also in an increase in the efficiency of the turbomachine. Furthermore, the use of hot steam for the vaporization of liquid fuel affords the advantage that there is no risk of a self-ignition or a flashback from the combustion chamber, because no oxygen is present in the steam/fuel mixture.

In an embodiment of the proposed method, superheated steam is produced in the heat exchanger by use of the exhaust gas energy in the turbine. Superheated steam has a high energy density, so that an undesired condensation of the vaporized water in the region of the fuel treatment system up to even the combustion of the fuel contained in the steam/fuel mixture is prevented.

In an embodiment of the proposed method, in the step b), a directed flow is formed in the steam when it is fed into the mixing chamber. The feeding of fuel to a steam having a directed flow makes it possible to achieve a homogeneous vaporization and intermixing of the fuel with the steam. For example, the directed flow can be produced by a swirl generator at the inlet of the mixing chamber, in which the steam is set into rotation and then the flow thereby formed enters a mixing chamber of the fuel treatment system.

In an embodiment of the proposed method, the fuel is atomized in the step c) and introduced into the directed flow of steam. The atomization improves the vaporization of the fuel, so that the formation of a homogeneous steam/fuel mixture is further assisted.

In an embodiment of the proposed method, the fuel is vaporized completely when it leaves the mixing chamber. Accordingly, when the steam/fuel mixture leaves the mixing chamber, the fuel is present only in gaseous form, as a result of which the steam/fuel mixture has favorable properties for a cleaner combustion of the fuel in the combustion chamber.

In an embodiment of the proposed method, steam produced in the heat exchanger is also introduced into a combustion chamber exterior space. A combustion chamber exterior space hereby refers to the remaining space inside of the combustion chamber housing and outside of the flame tube or of the combustion chamber, with the steam being introduced, in particular, upstream of the flame tube and of an injection device into the combustion chamber exterior space. For this purpose, a portion of the steam produced in the heat exchanger is available and is not required for the formation of the steam/fuel mixture in the mixing chamber of the fuel treatment system. In this way, it is possible to adjust variably the steam content in the combustion zone.

In an embodiment of the proposed method, steam produced in the heat exchanger is mixed in a diffusor with air that is conveyed by the compressor. In this way, it is possible to achieve a homogeneous mixing of the combustion air with the steam and, in consequence thereof, also with the steam/fuel mixture fed together with it for this purpose. For this, too, a part of the steam that is produced in the heat exchanger and is not required for the formation of the steam/fuel mixture in the mixing chamber of the fuel treatment system is available.

In an embodiment of the proposed method, an air and/or steam mixture, in which, in particular, a directed flow is formed during feeding to the combustion chamber, is supplied to the combustion chamber, whereby the gaseous fuel-steam mixture is introduced from the mixing chamber into this directed flow. As a result of the formation of the directed flow in the air and/or steam mixture, a largely homogeneous mixing of this mixture ensues, to which, in the combustion chamber, a largely homogenous premixed steam/fuel mixture is additionally supplied, so that, in the combustion chamber, a mixture with an advantageously homogeneous distribution of components is present, as a result of which a clean combustion can be achieved. The directed flow results in a stabilization of the flame. During the formation of a swirl flow, an area of recirculation can be generated and can ensure the stabilization of the flame. The backflowing hot combustion gases carry combustion radicals to the inflowing mixture and supply the energy needed for a continuous ignition. A rapid and complete combustion with a precisely controllable peak temperature is thereby possible. Besides a swirl flow, the directed flow can also form a jet flow.

In an embodiment of the proposed method, the fuel treatment system has at least two mixing chambers, in which steam/fuel mixtures with different mixing ratios are formed, whereby, in at least two regions of the combustion chamber, different flows are formed, into each of which, one of the steam/fuel mixtures is introduced. In this way, it is possible to use the method to form a staged combustion chamber with two combustion zones. Typically, a pilot combustion zone is hereby formed, in which, in the case of low load demands, such as idle, sufficient combustion energy is released, and a primary combustion zone, which can be engaged for higher load stages. By the formation of steam/fuel mixtures with different mixing ratios, it is possible for a part of the combustion in a pilot combustion zone to achieve an equivalence ratio that is largely independent of the load state.

In a second aspect for the solution of the problem, a turbomachine for a flight propulsion system with a combustion system is proposed, which comprises a compressor, a combustion chamber, and a turbine as well as a heat exchanger arranged downstream of the turbine for producing steam. The turbomachine hereby has a fuel treatment system that is connected to the combustion chamber for producing a steam/fuel mixture for supplying the combustion chamber.

In a second aspect for the solution of the problem, in particular, the turbomachine is hereby designed in such a way that it can be used to carry out one method step or a plurality of method steps of the previously described method for operating a combustion system of a turbomachine. The features and properties specified in the previous description hereby correspond in terms to the functionality and effect thereof also, in general, to the following described features and properties of the elements of the turbomachine.

In a second aspect for the solution of the problem, the proposed turbomachine has a fuel treatment system connected to the combustion chamber for producing a steam/fuel mixture for supplying the combustion chamber. In this way, the fuel vaporizes in a mixing chamber that is separated spatially from the combustion chamber and is supplied to the combustion chamber of the turbomachine only after its formation and in the form of steam/fuel mixture. This makes possible a homogeneous distribution of the fuel in the steam and a stable and homogeneous combustion in the combustion chamber, as a result of which, on the one hand, an increase in the efficiency of the turbomachine ensues and, on the other hand, the risk of a self-ignition or of a flashback from the combustion chamber is reduced, because no oxygen is available in the steam/fuel mixture.

In a second aspect for the solution of the problem, in an embodiment of the turbomachine, at least one flow generator for generating a directed flow in the introduced steam is arranged at the steam inlet of the mixing chamber. It is thereby possible for the steam to be guided into the mixing chamber in a directed manner and, in particular, in a stably flowing manner, as a result of which a homogeneous vaporization and mixing of the fuel with the steam can be achieved. For example, the flow generator can be designed as a swirl generator, which sets the steam into rotation when it enters the mixing chamber.

In a second aspect for the solution of the problem, an embodiment of the turbomachine has a steam-feeding device, which is set up to feed steam from the heat exchanger to the mixing chamber of the fuel treatment system and/or to the combustion chamber exterior space. The steam-feeding device can hereby be set up in such a way that, in particular, the quantity of steam that is fed to the fuel treatment system and/or to the combustion chamber exterior space can be metered in order to feed the required quantity of steam to them from the heat exchanger. For the quantity of steam that is fed to the fuel treatment system, it is also possible optionally to provide an independent steam generator in order to ensure the supply of the fuel treatment system with sufficient steam.

In a second aspect for the solution of the problem, in an embodiment of the turbomachine, the steam-feeding device is set up to feed steam to a diffusor arranged at the chamber inlet and/or to the combustion chamber exterior space further downstream, in particular in the region of the combustion chamber outlet. The division of the quantities of steam at the steam branching is hereby chosen in such way that, in particular, a quantity of steam that is introduced into a diffusor upstream of the combustion chamber. for example, together with the quantity of steam from the fuel treatment system in the combustion zone, having a precisely defined and, in particular, slightly rich equivalence ratio, reaches a temperature (for example, 1900 K under full load) that is favorable for low emissions. The homogeneously distributed steam with its high heat capacity hereby acts as a thermal load, as a result of which temperature peaks can be prevented. Furthermore, it is possible in this way to choose the residence time of the combustion gases in the combustion zone to be sufficiently long that the emissions of CO, UHC, and soot can be kept low.

In a second aspect for the solution of the problem, further steam fed with the steam feed or steam line downstream into the combustion chamber exterior space increases there the concentration of the steam. Taken from this region are the mass flows for the cooling of the combustion chamber, for the adjustment of the radial temperature distribution at the combustion chamber outlet, and for the cooling of the high-pressure turbine. On account of the higher heat capacity of the cooling medium, it is possible to reduce the cooling mass flow, as a result of which more oxygen is also available for the combustion.

In a second aspect for the solution of the problem, an embodiment of the turbomachine has a steam branching between the steam-feeding device to the mixing chamber of the fuel treatment system and the steam-feeding device to the combustion chamber exterior space. By the steam branching, it is possible to feed the steam produced in the heat exchanger to various devices of the turbomachine. Besides the feeding to the mixing chamber, it is possible to introduce different quantities of steam into the combustion chamber exterior space, in particular upstream of the combustion chamber or flame tube and the injection device. In particular, it is also possible to provide optionally a control valve for the steam branching. In this way, the division of the steam mass flows and thus the steam content in the combustion zone can be adjusted variably.

In a second aspect for the solution of the problem, an embodiment of the turbomachine has a check valve arranged between the combustion chamber exterior space and the mixing chamber for feeding of air from the combustion chamber exterior space to the fuel treatment system. Such a check valve is advantageous, in particular, during the operation of the turbomachine at operating points for which no steam is yet available (for example, during take-off). At such operating points, the check valve can be used to carry air from the combustion chamber exterior space to the fuel treatment system, as a result of which the fuel is premixed with air. On account of the low pressure and the low air temperature at such operating points, there also exists no danger of self-ignition in the mixing chamber. Nor is a flashback from the combustion chamber into the mixing chamber possible as long as the outlet speed from the fuel nozzle is higher than the flame propagation speed.

In a second aspect for the solution of the problem, an embodiment of the turbomachine has at least one injection device arranged at the inlet to the combustion chamber, which has at least one flow generator for generating a directed flow in the introduced steam/fuel mixture. Through the use of a flow generator, a very homogeneous distribution of all mixture components in the combustion chamber is accomplished in order to achieve a low-pollutant combustion. By use of different flow devices, it is possible to define especially effective combustion regions, in particular a pilot combustion zone and a primary combustion zone of the combustion.

In a second aspect for the solution of the problem, in an embodiment of the turbomachine, the injection device has at least two concentrically arranged flow generators. Thus, at least two flow fields are created, in particular concentrically with respect to one another, and, for example, can also be supplied with different quantities of fuel. Thus, in the combustion chamber, it is possible to provide various combustion regions in order to achieve an optimal efficiency for an especially clean combustion. At least one flow generator can hereby be designed as a so-called swirl generator, which forms, in particular, a roughly cylindrical jacket flow field. It is hereby possible to form at least two directed flows, which are arranged concentrically with respect to one another in the combustion chamber, such as, for example, especially effectively defined combustion regions for the pilot combustion zone and for the primary combustion zone.

In a second aspect for the solution of the problem, in a further aspect, a use of a turbomachine with a combustion system of the previously described kind for application of the likewise already described method for operating a combustion system of a turbomachine is proposed.

In a second aspect for the solution of the problem, conventional aircraft engine combustion chambers work with a global equivalence ratio in the range of approximately φ=0.15-0.4. At such lean mixing ratios, the fuel/air mixture is not combustible. For this reason, only a part of the air is fed into the primary zone, in which the actual combustion takes place. The residual air flow is admixed to the combustion gases downstream of the primary zone.

In a second aspect for the solution of the problem, in the new concepts described in the introduction, besides fuel and the air, additionally water is heated to the desired temperature at the outlet of the combustion chamber. In the air present, more fuel has to be combusted in order to make available the energy required for this purpose. Cyclic process studies show that the thermal efficiency and the specific power increase with increasing water content. Therefore, a quantity of water that is as large as possible is aimed for. A natural limitation is afforded by the quantity of oxygen present in the combustion air. Theoretically, it is possible to combust completely only so much fuel until the oxygen present is consumed. The use of large quantities of water thereby leads to increasing equivalence ratios. What is aimed for under full load is a near stoichiometric global equivalence ratio global of approximately 0.95-0.98 (slightly lean). At partial load, the global equivalence ratio is leaner. Thereby ensuing for this combustion system or the operation in a combustion chamber of a turbomachine is an operating range of approximately φ_{global}=0.5−0.98.

In a second aspect for the solution of the problem, in an embodiment of the proposed method or of the proposed turbomachine, the air that is required for the combustion is to be fed via an injection device 41 into the combustion chamber and only a small part is to be fed via the combustion chamber wall 42, such as, for example, for cooling purposes. In the entire combustion zone (primary zone), at full load, a slightly rich mixture with φ=approximately 1.02−1.05 is adjusted. In this near stoichiometric region, very high NO_{X} emissions would arise in a conventional combustion chamber on account of the high combustion temperatures.

In a second aspect for the solution of the problem, the division of the quantities of steam is chosen in such a way that, in particular, the quantity of steam introduced upstream of the combustion chamber, together with the quantity of steam from the fuel processing system in the combustion zone with a defined (slightly rich) equivalence ratio, attains a temperature (for example, 1900 K at full load) that is favorable for low emissions. The homogeneously distributed steam with its high heat capacity hereby acts as a thermal load, as a result of which temperature peaks are prevented. The residence time of the combustion gases in the combustion zone can thereby be chosen to be so long that the emissions of CO, UHC, and soot are also kept very low for this combustion concept. The steam fed into the combustion chamber exterior space further downstream increases there the steam concentration. Taken from this region are the mass flows for the cooling of the combustion chamber, for the adjustment of the radial temperature distribution at the combustion chamber outlet, and for the cooling of the high-pressure turbine. Because of the higher heat capacity of the cooling medium, it is also possible in this way to reduce the cooling mass flow. As a positive side effect, more oxygen is then available for the combustion.

In a second aspect for the solution of the problem, under the assumption that sulfur-free fuel is used, it is possible with this concept to reduce the concentration of all relevant pollutants in the exhaust gas in an equal manner:
In a second aspect for the solution of the problem- Less thermal NO_{X}=>The combustion temperature is controlled by the steam as a thermal load.
No/Little prompt NO_{X}=>Prevention of the formation of CH radicals, because no rich mixture is produced.
No/Little NO_{X} by way of the dinitrogen mechanism=>No lean premixing and no combustion temperatures that are too low.
No/Little CO=>No high peak temperatures at which CO₂ dissociates, adequate residence time for adequate combustion temperature.
No/Little UHC=>Adequate residence time for adequate combustion temperature.
No/Little soot=>No mixture with equivalence ratio >1.3, adequate residence time for adequate combustion temperature.

Conventional combustion chambers for low-pollutant combustion often tend to undergo fluctuations in combustion, especially in the case of leanly premixed flames. Because, in this concept, the combustion is operated with a stoichiometric mixing ratio and because, owing to the good premixing, fluctuations in the release of heat are minimized, this problem should not arise.

The global air-fuel ratio in combustion chambers of turbomachines of flight propulsion systems varies markedly during operation (approximately by a factor of 2). In the proposed concept, it varies in the range of approximately φ_{global}=approximately 0.5-0.98. During full-load operation, the global equivalence ratio is slightly lean (φ=0.95−0.98) and, in the combustion zone, slightly rich (φ=1.02−1.05). Thus, in the slightly rich designed combustion zone (primary zone) for the case of full load, a leaner mixing ratio can ensue for partial load. This can lead to lean blowout and to poor ignition and reignition properties. In order to prevent this, the mixing ratio in the combustion zone has to be adapted to the load. In an embodiment, for low partial load points (ground idle or flight idle), it is possible to use a check valve or shut-off valve to reduce or to shut off the feed of steam to the combustion chamber exterior space. For the same power, it is then necessary to inject more fuel, because the mass throughput is reduced. Accordingly, the equivalence ratio in the combustion zone is indirectly shifted to higher values (for example, φ_{idle}>0.6), as a result of which the margin to the lean blowout limit is enlarged. In this low load stage, too, the fuel can be vaporized with steam by using the fuel treatment system, because the exhaust gas temperature and thus the temperature of the produced steam is high. Advantageous for this purpose is a configuration with an additional heat exchanger. By way of the adjustment of the quantity of steam up to complete shut-off of the feed of steam in low partial load points, it is possible to shift the equivalence ratio to higher values and to reduce the risk of a blowout, but not to exclude it. Therefore, in this concept, an already known staged combustion chamber with two combustion zones can be used appropriately. Typically, such a staged combustion chamber has a pilot combustion zone, which, in the case of low load demands, such as idle, releases sufficient combustion energy, and a primary combustion zone, which, at higher load stages, can be engaged.

The previous embodiments of the invention relate to the combustion of fossil kerosene or sustainably produced liquid fuels (sustainable aviation fuel: SAF). Coming into consideration for future aircraft are also fuels such as hydrogen H₂, methane CH₄, or natural gas. In order to achieve an energy density that is as high as possible, these fuels are stored under high pressure or in deep-cooled cryogenic form. For large aircraft, only the storage in the cryogenic state comes into question in terms of weight and construction volume.

In order to combust these fuels in an engine combustion chamber, they need to be transformed, under circumstances, in a heat exchanger from the cryogenic state to the gaseous state. In the WET concept for condensing water from the exhaust gas or the like, the fuel can hereby be used as a heat sink for the different tasks, such as for cooling of engine oil or electronic components. These fuels have in part special properties. For example, during the combustion of hydrogen, problems arise on account of its high reactivity and high combustion rate in terms of a stable flame situation and the risk of flashback up to the stabilization of the reaction at the injection device. As a result of the high combustion temperature during the combustion of hydrogen, there is also the risk of NON formation.

The proposed combustion system can also be used advantageously for this fuel. The fuel is then carried in gaseous form into the fuel treatment system. In the mixing chamber, there takes place only a mixing with steam. The admixture of steam results, in particular, in a reduction in the reactivity and the combustion rate of hydrogen, as a result of which the described problems during the combustion are improved. In this case, too, the admixture of the air/steam mixture at the combustion chamber inlet achieves a very homogeneous distribution of air, fuel, and steam. The combustion temperature is thereby controlled quite well and, as a result, the nitrogen oxide (NO_{X}) formation is minimized.

### BRIEF DESCRIPTION OF THE DRAWING FIGURES

Further features, advantages, and possible applications of the invention ensue from the following description in conjunction with the figures. Shown are:

FIG. 1 is a schematic illustration of an exemplary turbomachine according to the invention;

FIG. 2 is a schematic illustration of a further exemplary turbomachine according to the invention;

FIG. 3 is a schematic illustration of an exemplary inlet region of a combustion chamber of a further exemplary turbomachine; and

FIG. 4 is a schematic illustration of a flowchart of an exemplary method according to the invention for operating a combustion system of a turbomachine.

### DESCRIPTION OF THE INVENTION

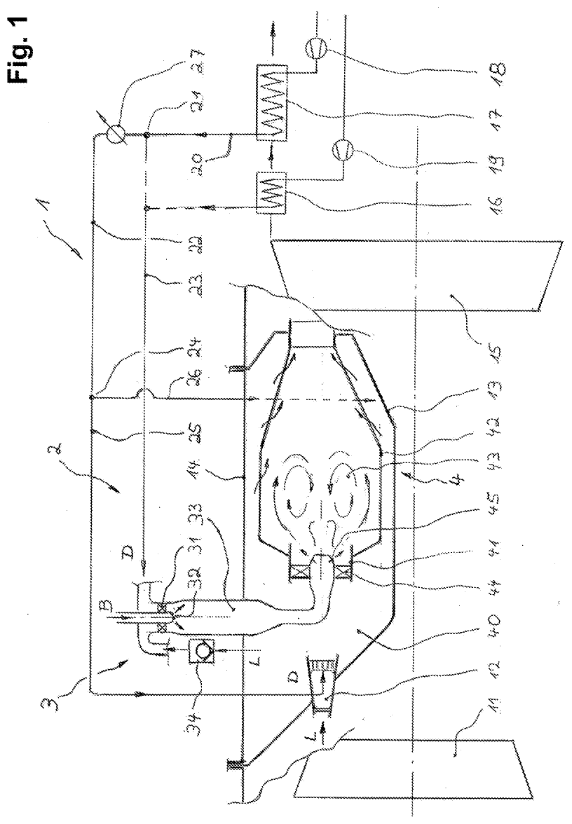

FIG. 1 shows a schematic illustration of an exemplary turbomachine 1 according to the invention for a flight propulsion system, comprising a combustion system 2, a compressor 11, a combustion chamber 4, a turbine 15, a heat exchanger 16, 17 arranged downstream of the turbine 15, and a fuel treatment system 3. Arranged downstream of the turbine 15 is a heat exchanger 17. The exhaust gas energy from the turbine 15 is used to produce superheated steam in the heat exchanger 16, 17. The steam is carried via the steam-feeding device 20 to a steam branching 21. There, a partial quantity of the steam is passed into a fuel treatment system by use of the steam-feeding device 23. The steam is set into rotation by use of a flow generator 31 and enters a mixing chamber 33. The fuel nozzle 21 is used to inject liquid fuel in finely atomized form into the directed flow. In the mixing chamber 33, the fuel is vaporized spatially separated from the combustion. The volume length and the flow length of the mixing chamber 33 are hereby chosen in such a way that, depending on the chosen quantity of steam and the temperature of the steam and fuel at the outlet of the mixing chamber 33, the fuel is vaporized as completely as possible. For the quantity of steam that is carried to the fuel treatment system 3, an independent steam generator 16 is optionally provided. The steam branching 21 can then be dispensed with. The quantities of steam can be adjusted by way of water reservoir pumps 18, 19 in such an optional embodiment.

The remaining quantity of steam is introduced using the steam feed 22 into the combustion chamber exterior space 40, which refers to the space remaining inside of the combustion chamber housing 13, 14 and outside of the combustion chamber wall 42. A partial quantity of the steam is introduced at the steam branching 24 into the combustion chamber exterior space 40 by use of the steam feed 25 upstream of the combustion chamber wall 42 and the injection device 41. It can be advantageous for a homogeneous mixing, as depicted in FIG. 1, for the steam to be mixed also in the diffusor 12 with the air fed from the compressor 11. The remaining steam from the steam feed 22 is introduced by use of the steam feed 26 into the combustion chamber exterior space 40 downstream near the combustion chamber outlet. The check valve/shut-off valve 27 can reduce or shut off the feed of steam to the combustion chamber for deep partial load points (ground idle or flight idle). For the steam branching 24, it is optionally possible also to provide a check valve (not depicted), by which the division of the steam mass flow and thus of the steam content in the combustion zone can be variably adjusted. Via a check valve 34, air can be carried from the combustion chamber exterior space 40 to the fuel treatment system 3 in order to premix the fuel with air at operating points at which no steam is yet available.

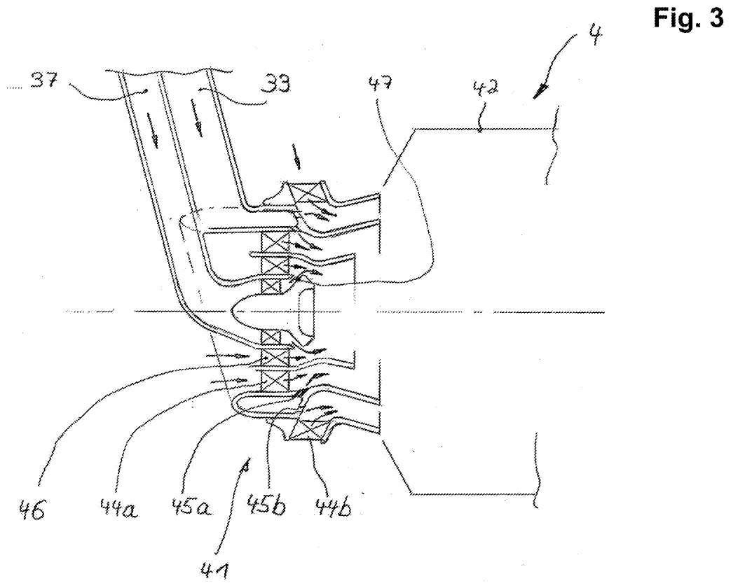

In the injection device 41, the air/steam mixture from the combustion chamber exterior space 40 is set into rotation by use of a flow generator 44, which, in the exemplary embodiment, is designed as a swirl generator. The gaseous fuel/steam mixture is then introduced into the directed flow from the mixing chamber 33. Because both partial flows are each well premixed, the additional mixing in the injection device 41 results in a mixture with a very homogeneous distribution of the components (fuel, air, steam). For increasing the homogeneity, it is possible for the mixing to occur by use of a plurality of concentrically arranged flow generators, in particular in the form of swirl generators (see FIG. 3). The directed flow can produce a recirculation area, which brings about a stabilization of the flame. The backflowing hot combustion gases carry combustion radicals and the energy needed for a continuous ignition to the inflowing mixture. A rapid and complete combustion with precisely controllable peak temperature is thereby possible. Apart from the swirl-stabilized flame depicted in FIG. 1, it is also possible, for the system to be applied to a jet-stabilized flame (not depicted).

The division of the quantities of steam at the steam branching 24 is chosen in such a way that, for example, the quantity of steam introduced by use of the steam-feeding device 25 upstream of the combustion chamber 4 (for example, in the diffusor 12), together with the quantity of steam from the fuel treatment system 3 in the combustion zone 43 with a precisely defined (slightly rich) equivalence ratio, achieves a temperature (for example, 1900 K at full load) that is favorable for low emissions. The steam that is carried further downstream into the combustion chamber exterior space 40 increases there the concentration of the steam.

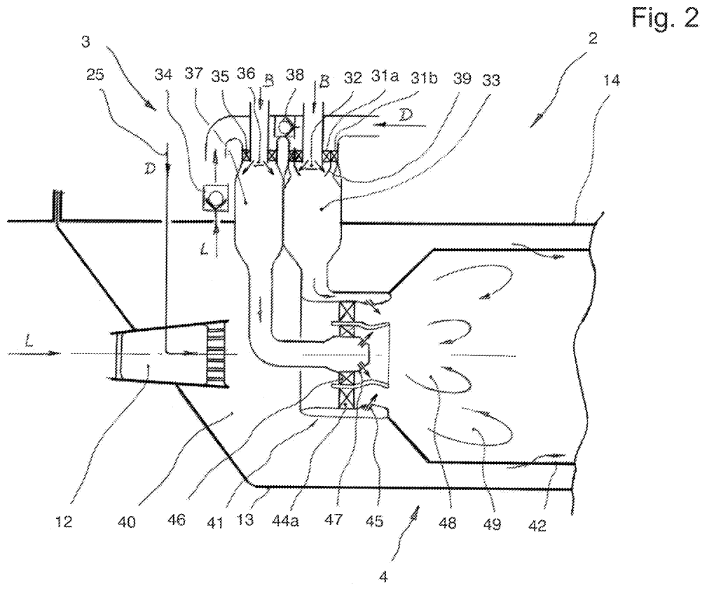

FIG. 2 shows a schematic illustration of a further exemplary turbomachine 1 according to the invention with a staged combustion chamber, which has two combustion zones. The staged combustion chamber 4 hereby has a pilot combustion zone 48, which releases sufficient combustion energy in the case of low load demands. Furthermore, the combustion chamber 4 has a primary combustion zone 49, which, at higher load stages, can be engaged. Here, a fuel gradation ensures that, for a portion of the combustion in the the pilot combustion zone 48, an equivalence ratio that is largely independent of the load state is achieved. Shown by way of example is an internally staged injection device 41, for which the pilot combustion zone 48 and the primary combustion zone 49 are concentrically arranged. Owing to the different swirls of air, defined combustion regions for the pilot combustion zone 48 and for the primary combustion zone 49 are formed. For the pilot combustion zone 48, a slightly rich to stoichiometric mixing ratio is aimed for. For the primary combustion zone 49 at full load, a slightly rich to stoichiometric equivalence ratio is likewise aimed for and, with decreasing power demand up to complete shut-off of the primary zone, becomes increasingly leaner.

The fuel for the central pilot combustion zone 48 and the primary combustion zone 49 is prevaporized using steam. An advantage of this combustion concept is the constant slightly rich pilot combustion zone 48, which affords a stable combustion and a large degree of safety with respect to blowout limits. In this concept, the emissions due to the combustion in the in pilot combustion zone 48 can be equally well controlled as those of the primary combustion zone 49 on account of the prevaporization of the fuel.

In FIG. 2, the fuel treatment system 3 for the pilot combustion zone 48 with the mixing chamber 37 is depicted with a flow generator 35. An even better atomization can be achieved when, as is depicted in the fuel treatment system 3 for the primary combustion zone 49, the fuel enters into the safety of two oppositely directed flows at the end of an atomizer 39.

The mixing chambers 33 and 37, depicted in FIG. 1 and FIG. 2 with the flow generators 31 and 35 as well as the fuel nozzles 32 and 36, are each assigned to an injection device 41 there. It is also conceivable that a mixing chamber 33, 37 is assigned to several or all injection devices 41. However, the implementation of a pilot combustion stage and primary combustion stage 48, 49 can also be combined in further variants with the present idea, such as, for example, by way of a separate flow generator 35, as in the so-called dual annular combustor (DAC) design.

FIG. 3 shows a schematic illustration of an exemplary inlet region in a combustion chamber 3 of a further exemplary turbomachine 1. Arranged in the inlet region of the combustion chamber 3 is an injection device 41, in which flow generators 44a, 44b are arranged. A fuel/steam mixture is introduced into each individual directed flow created by a flow generator 44a, 44b. In this way, a very homogeneous distribution of all mixture components is accomplished in order to achieve a low-pollutant combustion. Owing to the differently formed flows, it is possible to achieve especially effectively defined combustion regions for the pilot combustion zone 48 and for the primary combustion zone 49.

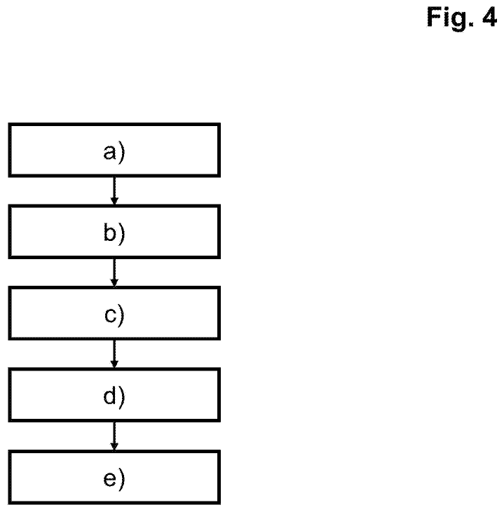

FIG. 4 shows a schematic illustration of a flowchart of an exemplary method according to the invention for operating a combustion system 2 of a turbomachine 1 for a flight propulsion system, comprising a compressor 11, a combustion chamber 4, a turbine 15, a heat exchanger 17 arranged downstream of the turbine 15, and a fuel treatment system 3. In a first step a), steam is produced in the heat exchanger 17 and, in the step b), steam produced in the heat exchanger 17 is fed into a mixing chamber 33, 37 of the fuel treatment system 3. In a step c), furthermore, fuel is fed into the mixing chamber 33, 37. In a step d), a steam/fuel mixture is formed in the mixing chamber 33, 37. In a step e), the steam/fuel mixture is fed into a combustion chamber 4 of the turbomachine 1.

1. A method for operating a combustion system of a turbomachine for a flight propulsion system, comprising a compressor, a combustion chamber, a turbine, a heat exchanger arranged downstream of the turbine, and a fuel treatment system comprising the steps of:
a) producing steam in the heat exchanger,
b) feeding the steam into a mixing chamber of the fuel treatment system,
c) feeding fuel into the mixing chamber of the fuel treatment system,
d) forming a steam/fuel mixture in the mixing chamber, and
e) supplying the steam/fuel mixture to a combustion chamber of the turbomachine.

2. The method for operating a combustion system according to claim 1, wherein the heat exchanger, superheated steam is produced from the exhaust gas energy in the turbine.

3. The method for operating a combustion system according to claim 1, wherein, in step b), a directed flow is formed in the steam when it is fed into the mixing chamber.

4. The method for operating a combustion system according to claim 3, wherein the fuel in step c) is finely atomized and introduced into the directed flow of steam.

5. The method for operating a combustion system according to claim 1, wherein the fuel at an outlet of the mixing chamber is completely vaporized.

6. The method for operating a combustion system according to claim 1, wherein the steam produced in the heat exchanger is also introduced into a combustion chamber exterior space.

7. The method for operating a combustion system according to claim 1, wherein the steam produced in the heat exchanger is mixed in a diffusor with the air fed from the compressor.

8. The method for operating a combustion system according to claim 1, wherein an air and/or steam mixture, in which a directed flow is formed, is fed into the combustion chamber, whereby the gaseous fuel/steam mixture from the mixing chamber is introduced into this the directed flow.

9. The method for operating a combustion system according to claim 1, wherein the fuel treatment system has at least two mixing chambers, in which steam/fuel mixtures with different mixing ratio are formed, wherein, in at least two regions of the combustion chamber, different flows are formed, into which each of the steam/fuel mixtures is introduced.

10. A turbomachine for a flight propulsion system with a combustion system, comprising:
a compressor, a combustion chamber, and a turbine, as well as a heat exchanger arranged downstream of the turbine for producing steam,
a fuel treatment system connected to the combustion chamber configured and arranged for producing a steam/fuel mixture for feeding into the combustion chamber.

11. The turbomachine with a combustion system according to claim 10, wherein, at a steam inlet to a mixing chamber, at least one flow generator is arranged which is configured and arranged for producing a directed flow in the steam that is introduced.

12. The turbomachine with a combustion system according to at claim 10, wherein a steam-feeding device, which is configured and arranged to feed steam from the heat exchanger to the mixing chamber of the fuel treatment system and/or to a combustion chamber exterior space.

13. The turbomachine with a combustion system according to claim 12, wherein the steam-feeding device is configured and arranged to feed steam to a diffusor arranged at the combustion chamber inlet and/or to the combustion chamber exterior space further downstream in the region of the combustion chamber outlet.

14. The turbomachine with a combustion system according to claim 12, wherein a steam branching between the steam-feeding device to the mixing chamber of the fuel treatment system and the steam-feeding device to the combustion chamber exterior space.

15. The turbomachine with a combustion system according to at claim 10, wherein a check valve, is arranged between the combustion chamber exterior space and the mixing chamber configured and arranged for feeding air from the combustion chamber exterior space to the fuel treatment system.

16. The turbomachine with a combustion system according to by claim 10, wherein at least one injection device, which is arranged at the inlet to the combustion chamber and which has at least one flow generator which is configured and arranged for producing a directed flow in the steam/fuel mixture that is introduced.

17. The turbomachine with a combustion system according to claim 16, wherein the injection device has at least two concentrically arranged flow generators.

18. Use of a turbomachine with a combustion system according to claim 10.

19. Use of a turbomachine according to the method for operating a combustion system of a turbomachine according to claim 1.
